(19) United States
(12) Patent Application Publication
(10) Pub. No.: US 2013/0079979 A1
(43) Pub. Date: Mar. 28, 2013

(54) TOWED VEHICLE ARRANGEMENT RESPONSIVE TO LATERAL HITCH LOADING

(71) Applicants: Alan D. Sheidler, Moline, IL (US); Noel W. Anderson, Fargo, ND (US)

(72) Inventors: Alan D. Sheidler, Moline, IL (US); Noel W. Anderson, Fargo, ND (US)

(21) Appl. No.: 13/241,898

(22) Filed: Sep. 23, 2011

(51) Int. Cl. B62D 59/04

(52) U.S. Cl. 701/36; 180/14.2

(57) ABSTRACT

A vehicle arrangement includes a tow vehicle and a towed vehicle. The towed vehicle includes at least two wheels and at least one motor, with each motor being coupled with a corresponding wheel. A load sensing hitch between the tow vehicle and towed vehicle senses a lateral load and provides an output signal representing the sensed lateral load. An electrical processing circuit is coupled with the load sensing hitch, and actuates at least one motor, dependent upon the output signal.

### FIELD OF THE INVENTION

The present invention relates to arrangements for towing a towed vehicle behind a tow vehicle, and, more particularly, to arrangements for towing a towed implement behind a work vehicle.

### BACKGROUND OF THE INVENTION

When using agricultural equipment, it is common to pull a towed vehicle behind a tow vehicle. For example, during a harvesting operation, it is common to pull a grain cart or gravity box behind a tractor. When the grain bin in the combine is full, the grain cart or gravity box is pulled along side of the combine, the unloading auger is swung to the side of the combine, and the grain is offloaded into the cart or gravity box. The full cart or gravity box may then be transported to a dryer location, such as an on-farm batch or bin dryer, or a local elevator.

As another example, it is also common to pull a fertilizer spreader behind a tractor for application of fertilizer, lime, etc. to an agricultural field.

When pulling a towed vehicle such as an agricultural cart, wagon, spreader or the like behind a tractor, the weight of the towed vehicle when full with product can be substantial. For this reason, it is common to use a relatively large tractor to pull such a towed vehicle. The weight effects of a towed vehicle on a tow vehicle are further compounded when a number of towed vehicles are connected together in a train arrangement, such as a number of loaded gravity boxes which are trained together and pulled to a dryer location using a single tractor.

What is needed in the art is a way of towing a heavy towed vehicle or train of towed vehicles, without adversely affecting the operation of the tow vehicle.

### SUMMARY

The present invention provides a towed vehicle arrangement in which one or more wheels on the towed vehicle are driven and/or braked in response to a sensed lateral hitch loading.

The invention in one form is directed to a vehicle arrangement including a tow vehicle and a towed vehicle. The towed vehicle includes at least two wheels and at least one motor, with each motor being coupled with a corresponding wheel. A load sensing hitch between the tow vehicle and towed vehicle senses a lateral load and provides an output signal representing the sensed lateral load. An electrical processing circuit is coupled with the load sensing hitch, and actuates at least one motor, dependent upon the output signal.

The invention in another form is directed to a method of towing a towed vehicle using a tow vehicle. The towed vehicle has at least one motor with each motor being coupled with a corresponding wheel. The method includes the steps of: sensing a lateral load using a load sensing hitch between the tow vehicle and the towed vehicle; outputting an output signal from the load sensing hitch representing the sensed lateral load; and actuating at least one motor using an electrical processing circuit, dependent upon the output signal.

### BRIEF DESCRIPTION OF THE DRAWINGS

The above-mentioned and other features and advantages of this invention, and the manner of attaining them, will become more apparent and the invention will be better understood by reference to the following description of embodiment of the invention taken in conjunction with the accompanying drawings, wherein:

FIG. 1 is a perspective view of an embodiment of a towed vehicle of the present invention in the form of a fertilizer spreader;

FIG. 2 is a schematic view of the fertilizer spreader shown in FIG. 1;

FIG. 3 is a schematic top view of a towed vehicle when encountering an obstruction, showing reactionary forces;

FIG. 4 is a schematic top view of a towed vehicle when encountering an obstruction, but with electric motor(s) actuated;

FIG. 5 is a schematic top view of a towed vehicle when turning, showing reactionary forces, and with electric motor(s) actuated; and

FIG. 6 is a flowchart illustrating an embodiment of a method of the present invention for towing a towed vehicle.

Corresponding reference characters indicate corresponding parts throughout the several views. The exemplification set out herein illustrates an embodiment of the invention, in one form, and such exemplification is not to be construed as limiting the scope of the invention in any manner.

### DETAILED DESCRIPTION

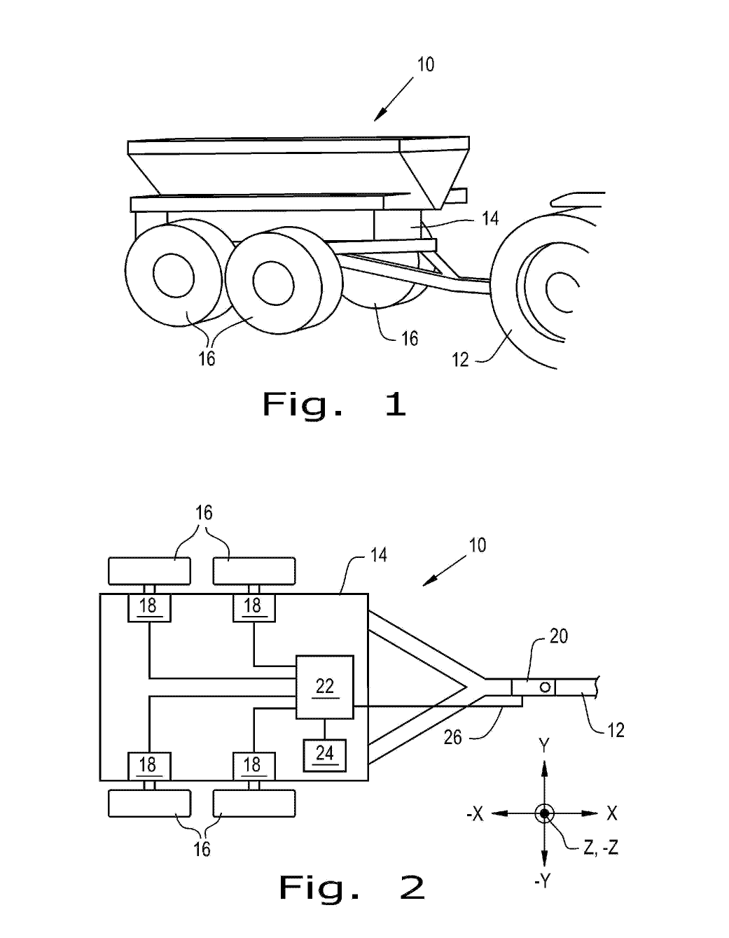

Referring now to the drawings, and more particularly to FIG. 1, there is shown an embodiment of a vehicle arrangement of the present invention including a towed vehicle 10 which is towed by a tow vehicle 12. Towed vehicle 10 is shown in the form of a fertilizer spreader in the illustrated embodiment, but could be any type of other towed vehicle. For example, towed vehicle 10 could also be in the form of a grain cart, a gravity box, and air cart, etc.

Towed vehicle 10 (FIGS. 1 and 2) generally includes a frame 14, at least two wheels 16 carried by frame 14, at least one motor 18, a load sensing hitch 20, and an electrical processing circuit 22. In the illustrated embodiment, towed vehicle 10 includes four wheels 16, but may include a different number of wheels, depending on the application.

Towed vehicle 10 is shown as including four motors 18 which are respectively coupled with a corresponding wheel 16. However, towed vehicle 10 need not necessarily include a motor 18 associated with each corresponding wheel 16. For example, towed vehicle 10 could be provided with a pair of motors 18 with a single motor on each side. Motors 18 are assumed to be electric motors in the illustrated embodiment, but could be differently configured depending on the application, such as hydraulic motors.

When configured as electric motors, it is desirable to provide towed vehicle 10 with an onboard source of electrical power, such as a single battery 24 or a bank of batteries. The electrical power could also be obtained from an onboard internal combustion engine (i.e., the alternator/generator output of such an engine). Alternatively, it is also possible to obtain electrical power from a similar electrical source onboard tow vehicle 12.

Load sensing hitch 20 senses a load along an axis which is generally perpendicular to a longitudinal or travel direction of towed vehicle 10 and/or tow vehicle 12. Load sensing hitch 20 may also be configured to sense loads along 3 separate axes defining a 3-D coordinate system, but for purposes of this invention, it is the lateral direction that is important. In the illustrated example, load sensing hitch 20 may be provided with load cells to sense loads along the plus or minus X, Y and/or Z directions (the Z direction extending perpendicular to the drawing plane of FIG. 2). A load sensed in the transverse or lateral (Y) direction may be used, e.g., to sense a turning maneuver or wheel dropping into a hole, and in turn apply an acceleration or braking torque to achieve a torque vectoring of towed vehicle 10.

The specific configuration of load sensing hitch 20 may vary, depending on the application. For example, load sensing hitch 20 may include one or more load cells for detecting lateral loading. Moreover, load sensing hitch 20 is shown as being coupled with and carried by a portion of the tongue or hitch of towed vehicle 10, but could also be carried by the hitch extending rearward from tow vehicle 12, or even potentially partially carried by each of towed vehicle 10 and tow vehicle 12. Other configurations are also possible.

Electrical processing circuit 22 receives an output signal from load sensing hitch 20 and actuates one or more motors 18, dependent upon the output signal. Electrical processing circuit 22 is shown as being connected with load sensing hitch 20 via a single line 26, but could be coupled in a different manner such as a data bus, wireless connection, etc.

More specifically, electrical processing circuit 22 compares a value of the output signal from load sensing hitch 20 representing lateral loading with an acceptable load range. If the value of the output signal falls within this acceptable load range, then none of the motors 18 are actuated. On the other hand, if the value of the output signal falls outside of this acceptable load range, then one or more motors 18 are actuated to apply a desired thrust or braking action to the corresponding wheel. In this manner, towed vehicle 10 is independently accelerated or decelerated apart from any pulling force applied by tow vehicle 12. Electrical processing circuit 22 actuates one or more motors 18 such that an amount of thrust or braking that is applied to a corresponding motor 18 is proportional to a magnitude of the lateral hitch loading.

It is also possible to limit the torque which is applied to a motor 18 such that damage does not occur to the chassis, drive train, etc. For example, electrical processing circuit 22 may be configured to apply a command signal effecting a maximum torque to a given motor 18 and wheel 16 which is less than a maximum threshold amount. Furthermore, it may be possible to simply limit the maximum output torque of a given motor 18 so that the maximum torque is below a threshold value.

Referring now to FIG. 3, there is shown a top schematic view of a hypothetical occurrence in which a wheel of a towed vehicle in the form of a towed implement falls into a hole in a field. More specifically, as tow vehicle (tractor) 12 is moving forward, the right hand wheel of the towed implement 10 encounters an obstruction in the form of a hole in the field. The obstruction resists forward motion of towed implement 10, which causes towed implement 10 to decelerate but due to the uneven loading on the right hand side of towed implement 10, a moment is also created. Due to the deceleration of towed implement 10, there is an instantaneous increase in the hitch load along the direction of travel. The tractor 12 sees a reaction force from towed implement 10 directly opposite the direction of travel. The induced moment in towed implement 10 from the obstruction creates a force vector to the left on the implement side of the hitch. The tractor side of the hitch reacts the implement side force but this reaction force is to the right. The tractor drive tires also react the force from the hitch, but this time the force is to left. The front tractor tires also must react to the hitch load as shown. The reaction forces generated by the resistance force of the obstruction cause an increase in the hitch tension and side loading in the hitch. If the side loading is sufficiently large, the rear of the tractor can inadvertantly slide to the left. The driver may have to steer the tractor to compensate for these effects.

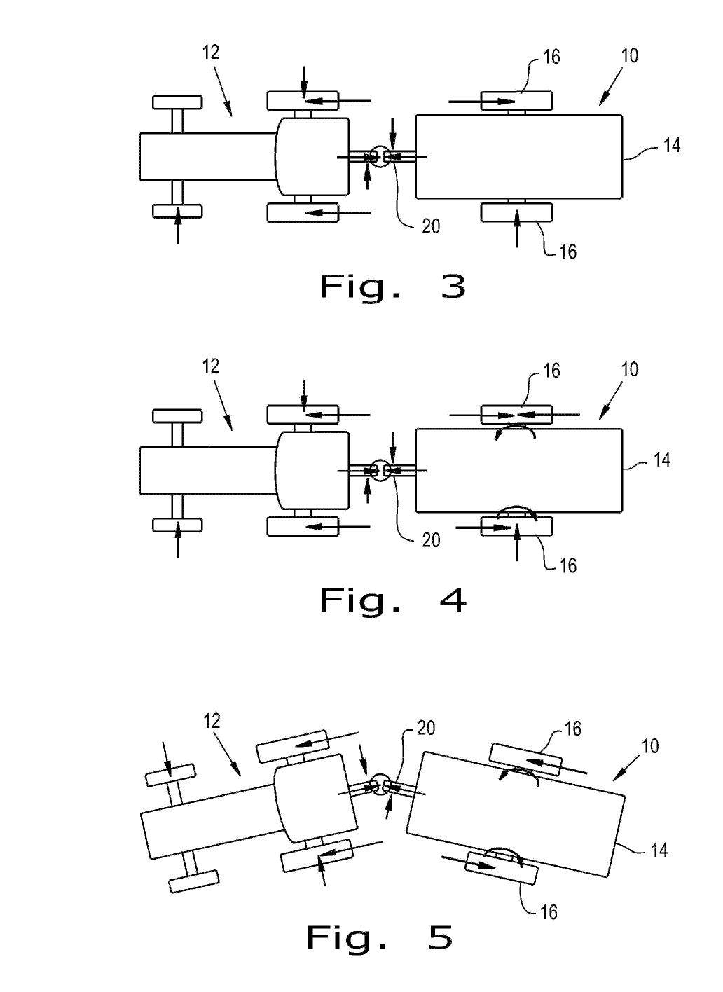

Referring now to FIG. 4, there is shown a top schematic view of a hypothetical occurrence similar to FIG. 3, but in this instance electric motors in towed implement 10 are actuated to counteract the obstruction. More specifically, as tow vehicle 12 is moving forward, the right hand wheel of towed implement 10 encounters an obstruction in the form of a hole. The obstruction resists forward motion of towed implement 10. This causes towed implement 10 to decelerate but due to the uneven loading on the right hand side of towed implement 10, a moment is also created. Due to the deceleration of towed implement 10, there is an instantaneous increase in hitch load along the direction of travel. There is an increase in the load on load sensing hitch 20 along the direction of travel and to the side as in FIG. 3, and the load sensor in load sensing hitch 20 detects these perpendicular forces. Electrical processing circuit 22 receives the sensed change in side loading and draft load, and computes the magnitude of the resistance force vector from the obstruction. Electrical processing circuit 22 commands electric motors 18 in towed implement 10 to respond to reduce or eliminate the resistance force vector. The right hand wheel motor provides positive driving torque and the left hand motor provides braking torque, if needed. In this way, the trailer moment due to the obstruction is negated. Tractor 12 can more easily maintain a straight trajectory requiring minimal or no steering corrections. Since energy can be transferred electrically from the left hand motor (a generator) to the right hand motor (a motor), much of the trailer moment can be negated without addition of energy to the system. If a storage battery is added to the system, both motors can work as motors to reduce the draft load to the tractor to negotiate severe obstructions.

Referring now to FIG. 5, there is shown a top schematic view of a hypothetical occurrence in which tow vehicle or tractor 12 turns and towed implement 10 uses electric motors to counteract moments. More specifically, as the vehicle is moving forward, the tractor turns to the left. Depending on the speed and direction, a moment is generated in the trailer. The electric drive motor 18 at each wheel 16 responds to counteract the induced moment. The trailer hitch load sensor is equipped with an angle sensor to determine the hitch angle between tractor 12 and implement 10 while steering. If the draft loads and side loads of the hitch do not correspond to the expected steering maneuver, electrical processing circuit 22 commands drive motors 18 at each wheel 16 to provide drive torque or braking torque to reduce the hitch side load. Tractor 12 is able to complete the steering maneuver more accurately, without tractor 12 sliding sideways or having to correct by over or understeering. Centrifugal force can also be considered as an externally acting force and is computed by electrical processing circuit 22 according to the travel speed and hitch angle.

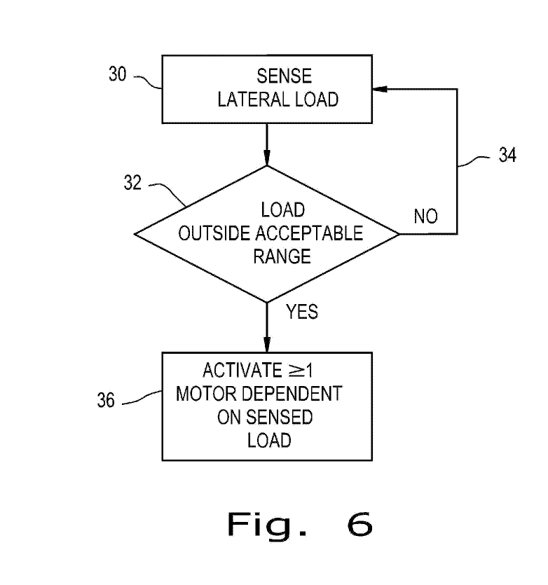

Referring now to FIG. 6, there is shown a simplified illustration of a method of towing a towed vehicle 10 of the present invention. At box 30, a lateral load on load sensing hitch 20 is sensed. If the output signal for the sensed lateral load falls within a given acceptable range, then tow vehicle 12 simply continues to pull the towed vehicle 10 without assistance from motors 18 (block 32 and line 34). On the other hand, if the output signal for the sensed lateral load falls outside of a given acceptable range, then electrical processing circuit 22 actuates one or more electric motors 18 to apply a thrust or braking action to a corresponding wheel 16, as desired and appropriate (block 36).

The present invention has an advantage in that a large tow vehicle 12 is no longer needed to pull or tow a heavy towed vehicle 10. This allows the size of the tow vehicle 12 to be decreased, which in turn decreases the cost of the required vehicle as well as associated operating costs like fuel, etc. The towed vehicles 10 can even be coupled together in a train arrangement while still allowing the use of a relatively small tow vehicle 12.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A vehicle arrangement, comprising:
a tow vehicle;
a towed vehicle including at least two wheels and at least one motor, each said motor being coupled with a corresponding said wheel;
a load sensing hitch between said tow vehicle and said towed vehicle, said load sensing hitch sensing a lateral load and providing an output signal representing a sensed lateral load on said load sensing hitch; and
an electrical processing circuit coupled with said load sensing hitch, said electrical processing circuit actuating at least one said motor, dependent upon said output signal.

2. The vehicle arrangement of claim 1, wherein said towed vehicle includes said load sensing hitch.

3. The vehicle arrangement of claim 1, wherein said electrical processing circuit compares a value of said lateral loading with an acceptable load range, and actuates at least one said motor if said value is outside of said acceptable load range.

4. The vehicle arrangement of claim 1, wherein said lateral load is perpendicular to at least one of: 1) a fore and aft axis of said towed vehicle; and 2) a fore and aft axis of said tow vehicle.

5. The vehicle arrangement of claim 1, wherein said electrical processing circuit actuates at least one said motor to provide one of thrust and braking to a corresponding said wheel.

6. The vehicle arrangement of claim 5, wherein said at least one motor includes a first motor on one side of said towed vehicle and a second motor on an opposite side of said towed vehicle, and said electrical processing circuit actuates said first motor to apply a thrust torque and actuates said second motor to apply a braking torque.

7. The vehicle arrangement of claim 5, wherein an amount of thrust or braking that said at least one motor applies to a corresponding said wheel is proportional to a magnitude of the lateral loading on said load sensing hitch.

8. The vehicle arrangement of claim 5, wherein one of said electrical processing circuit and said at least one motor includes a torque limiter for limiting an amount of said thrust or braking that is applied to said at least one motor.

9. The vehicle arrangement of claim 1, including an angle sensor for sensing a relative angular orientation between said tow vehicle and said towed vehicle.

10. The vehicle arrangement of claim 1, wherein said motor is an electric motor.

11. The vehicle arrangement of claim 10, including an electrical power source for providing electrical power to said at least one motor.

12. The vehicle arrangement of claim 11, wherein said electrical power source includes one of a) at least one battery, and b) an internal combustion engine.

13. The vehicle arrangement of claim 1, wherein said towed vehicle is a towed implement.

14. A method of towing a towed vehicle using a tow vehicle, the towed vehicle having at least one motor with each motor being coupled with a corresponding wheel, said method comprising the steps of:
sensing a lateral load using a load sensing hitch between said tow vehicle and said towed vehicle;
outputting an output signal from said load sensing hitch representing said sensed lateral load; and
actuating at least one said motor using an electrical processing circuit, dependent upon said output signal.

15. The method of claim 14, wherein said sensed lateral load is compared with an acceptable load range on said load sensing hitch, and said actuating step is carried out if said sensed lateral load is outside of said acceptable load range.

16. The method of claim 14, wherein said lateral load is perpendicular to at least one of: 1) a fore and aft axis of said towed vehicle; and 2) a fore and aft axis of said tow vehicle.

17. The method of claim 14, wherein said actuating step is carried out such that said at least one motor provides one of thrust or braking to a corresponding said wheel.

18. The method of claim 17, wherein said at least one motor includes a first motor on one side of said towed vehicle and a second motor on an opposite side of said towed vehicle, and said electrical processing circuit actuates said first motor to apply a thrust torque and actuates said second motor to apply a braking torque.

19. The method of claim 17, wherein an amount of thrust or braking that said at least one motor applies to a corresponding said wheel is proportional to a magnitude of said sensed lateral load.

20. The method of claim 17, wherein one of said electrical processing circuit and said at least one motor includes a torque limiter for limiting an amount of said thrust or braking that is applied to said at least one motor.

21. The method of claim 14, including the step of sensing a relative angular orientation between said tow vehicle and said towed vehicle.

22. The method of claim 17, wherein said motor is an electric motor.

23. The method of claim 14, wherein said towed vehicle is a towed implement.

24. A towed vehicle arrangement, comprising:
a frame;
at least two wheels carried by said frame;
at least one motor, each said motor being coupled with a corresponding said wheel;
a load sensing hitch for sensing a lateral load thereon, said load sensing hitch providing an output signal representing the sensed lateral load; and
an electrical processing circuit coupled with said load sensing hitch, said electrical processing circuit actuating at least one said motor, dependent upon said output signal.

25. The towed vehicle arrangement of claim 24, wherein said electrical processing circuit compares a value of said lateral loading with an acceptable load range, and actuates at least one said motor if said value is outside of said acceptable load range.

26. The towed vehicle arrangement of claim 24, wherein said lateral load is perpendicular to at least one of: 1) a fore and aft axis of said towed vehicle; and 2) a fore and aft axis of said tow vehicle.

27. The towed vehicle arrangement of claim 24, wherein said electrical processing circuit actuates at least one said motor to provide one of thrust and braking to a corresponding said wheel.

28. The towed vehicle arrangement of claim 27, wherein said at least one motor includes a first motor on one side of said towed vehicle and a second motor on an opposite side of said towed vehicle, and said electrical processing circuit actuates said first motor to apply a thrust torque and actuates said second motor to apply a braking torque.

29. The towed vehicle arrangement of claim 27, wherein an amount of thrust or braking that said at least one motor applies to a corresponding said wheel is proportional to a magnitude of the lateral loading on said load sensing hitch.

30. The vehicle arrangement of claim 27, wherein one of said electrical processing circuit and said at least one motor includes a torque limiter for limiting an amount of said thrust or braking that is applied to said at least one motor.

31. The towed vehicle arrangement of claim 24, including an angle sensor for sensing a relative angular orientation between said tow vehicle and said towed vehicle.
